(19) United States
(12) Patent Application Publication
(10) Pub. No.: US 2025/0050370 A1
(43) Pub. Date: Feb. 13, 2025

(54) Spray Head Improvements for an Ultrasonic Spray Coating Assembly

(71) Applicant: Ultrasonic Systems, Inc., Haverhill, MA (US)

(72) Inventors: Stuart J. Erickson, Marblehead, MA (US); Drew D. Erickson, Newbury, MA (US)

(21) Appl. No.: 18/659,306

(22) Filed: May 9, 2024

Related U.S. Application Data
(63) Continuation of application No. 13/441,958, filed on Apr. 9, 2012.

(51) Int. Cl. B05B 17/06; B06B 3/00

(52) U.S. Cl. CPC B05B 17/0669; B05B 17/0623; B06B 3/00

(57) ABSTRACT

Disclosed is an ultrasonic spray coating system wherein (1) the surface of the feed blade of the ultrasonic spray head has been modified to add a series shallow channels to redirect the ultrasonic surface wave system that exists on the surface; (2) the internal passageway of the liquid applicator has been modified to add a series of channels to uniformly feed the liquid from the liquid applicator to the spray-forming tip; (3) a positive displacement pump is utilized to deliver the liquid to the spray head at a precise flow rate independent of the associated resistances of the liquid delivery system components; and (4) the output orifice of the primary gas director is extended to impinge the directed gas stream at a position closer to the spray-forming tip.

### CROSS-REFERENCE TO RELATED APPLICATION

This application is a continuation of commonly owned U.S. application Ser. No. 13/441,958, filed on Apr. 9, 2012, the disclosure of which is hereby incorporated herein by reference.

### FIELD OF THE INVENTION

The present invention provides spray head improvements for use in an ultrasonic spray assembly. This invention represents an improvement over prior art spray devices, in which the coating pattern width, coating deposition uniformity, flow rate range at which a stable spray pattern can be produced, and drop size distribution are greatly improved.

### BACKGROUND OF THE INVENTION

There is an increasing need in industry to apply coatings to substrates in very thin, uniform layers at high production rates, such as the application of phosphorus based dopants to solar cell wafers. For example a typical coating deposition requirement is 0.00015 ml of liquid coating per square centimeter, which translates to a wet film thickness of 1.5 μm.

Current techniques for the application of thin coatings include spin coaters, fog coaters, spray nozzles and ultrasonic spray heads.

Spin coating involves spinning the substrate at a high speed and applying the coating to the rotating substrate. The coating forms a thin film on the surface as it is spun off the substrate due to the centrifugal forces from the high-speed rotation. The coating thickness is inversely proportional to the rotation speed of the substrate and the length of time that it is rotated. Spin coating techniques produce a very thin and uniform coating. However, the process is inherently slow because the substrates need to be processed one at a time. Additionally, over 90% of the coating liquid is wasted during the spin coating process. Therefore the spin coating method is not suited to high volume production due to the time required to achieve the thin coating and the waste of coating liquid.

Fog coating systems consist of stationary atomizers that produce a very fine mist similar to humidification. The substrates are exposed to the fine mist as they pass beneath the atomizers. The coating thickness is proportional to the density of the fog and inversely proportional to the conveyor speed. Fog coating systems are highly susceptible to the surrounding ambient conditions; changes in temperature and humidity as well as spurious air currents will influence the deposition of the mist onto the substrates thus making process control difficult.

An array of stationary spray nozzles mounted over a moving conveyor is another method of applying coatings to substrates. The coating is applied to the substrates as they pass beneath the spray nozzles. The coating thickness is proportional for the coating flow rate and inversely proportional to the conveyor speed. Spray nozzles produce a conical spray pattern and hence a parabolic coating distribution on the substrate depositing more coating at the center of the pattern and less at the edges, thus producing a non-uniform coating deposition on the substrates. Additionally, spray nozzles have a minimum flow rate at which they can produce a stable spray pattern, which limits the ability of the nozzles to apply a thin coating. Thus, stationary spray nozzles are not suitable for the application of thin, uniform coatings.

The use of a traversing ultrasonic spray head to achieve thin, uniform coating layers has been successful-within certain limits. This technique involves using an ultrasonic spray head that traverses and sprays the coating over moving substrates as they pass below on a conveyor. The coating thickness is proportional to the liquid flow rate and inversely proportional to the traversing speed of the spray head. The motion of the traversing head is synchronized with the conveyor speed to achieve a uniform coating deposition on the substrates. However, the ultrasonic spray heads have a minimum flow rate at which they can produce a stable, uniform spray pattern. This limits the efficacy of this technique to achieve the increasing requirements for ultra-thin coating layers.

In summary, although spin coating provides excellent coating results it is not suitable for high volume production; the results obtained with the fog coating techniques are subject to changes in the surrounding ambient conditions; and stationary spray nozzles do not produce a uniform coating deposition or a thin coating layer.

The present invention provides an ultrasonic spray coating assembly that represents an improvement over the ultrasonic spray systems described in U.S. Pat. Nos. 5,409,163, 5,540,384, 5,582,348, 5,622,752, 7,934,665 and 7,975,938, the disclosures of which are hereby incorporated herein by reference. The ultrasonic spray coating system of the present invention can be used in the methods taught in these patents, and can also be used as described herein.

### SUMMARY OF THE INVENTION

The present invention is directed to an improved feed blade and an ultrasonic spray coating system utilizing the improved feed blade, wherein (1) the surface of the feed blade of the ultrasonic spray head has been modified to add a series shallow channels to redirect the ultrasonic surface wave system that exists on the surface; (2) the internal passageway of the liquid applicator has been modified to add a series of channels to uniformly feed the liquid from the liquid applicator to the spray-forming tip; (3) a positive displacement pump is utilized to deliver the liquid to the spray head at a precise flow rate independent of the associated resistances of the liquid delivery system components; and (4) the output orifice of the primary gas director is extended to impinge the directed gas stream at a position closer to the spray-forming tip.

One embodiment of the invention is thus directed to an ultrasonic spray coating system comprising:
(a) a converter for converting high frequency electrical energy into high frequency mechanical energy to thereby produce vibrations,
(b) a spray forming head coupled to said converter, said spray forming head having a narrowed spray forming tip with substantially planar opposing side surfaces, the spray forming tip terminating at a substantially planar atomizing surface, one of the side surfaces comprising a feed blade being substantially perpendicular to the atomizing surface;
(c) a high frequency alternating generator electrically connected to said converter for producing a controllable level and frequency of electrical energy at an operating frequency of said spray forming head and converter wherein the atomizing surface is uniformly displaced in a normal direction by the vibrations and wherein a surface wave component is induced in the first region along the feed blade, the surface wave component being in a direction toward the atomizing surface;
(d) a liquid applicator in close proximity with the first region of said feed blade and spaced therefrom, said liquid supply applicator having an output surface including an orifice therein, such that liquid supplied from the output orifice to the feed blade is caused to flow to and on said atomizing surface under the influence of said surface wave component and said liquid is atomized by the displacement of said atomizing surface and is thereby changed to a spray; and
(e) a controllable gas entrainment mechanism associated with said spray forming head, the gas entrainment mechanism including a primary gas director for directing a first stream of gas at a region of the side surface of the spray forming tip opposite said feed blade, an angle measured between the first stream of gas and the side surface opposite said feed blade being less than 90° such that the first stream of gas impinges off the region thereby forming a fan-shaped air pattern in a direction substantially normal to the atomizing surface for affecting and controlling said spray.

In certain embodiments of the invention, the surface feed blade comprises a series of shallow channels to redirect and concentrate the surface wave component that exists on this surface, such that the surface wave has three directional components in the x, y and z planes. In certain embodiments, the inside orifice of the liquid supply applicator comprises a series of liquid guide channels to form a liquid flow guide. In certain embodiments, the output orifice of the primary gas director is extended to bring the output orifice closer to the impingement surface of the spray forming head.

In certain embodiments, the surface wave with three (3) directional components redirects the liquid flow over the surface of the feed blade to form a film with a more uniform thickness. In certain embodiments wherein the surface wave with three (3) directional components pumps the more uniform liquid film to the atomizing surface of the spray forming tip producing a spray containing drops with a smaller median drop size. In certain embodiments wherein the surface wave with three (3) directional components pumps the more uniform liquid film to the atomizing surface of the spray forming tip producing a spray containing drops with a more uniform drop size distribution.

In certain embodiments, the ultrasonic spray coating system further comprises a positive displacement pump to deliver liquid to the spray forming tip at a precise flow rate independent of the associated resistance to flow created by the liquid guide channels inside the liquid supply applicator. In certain embodiments, the extended output orifice of the primary gas director enables the ultrasonically produced spray to be expanded to a greater expanded width by more than a factor of two (2).

In certain embodiments, the combination of the modified feed blade surface and the modified liquid supply applicator orifice enables a uniform spray to be produced by the spray forming tip at a substantially lower flow rate. In certain embodiments, the modified liquid supply applicator orifice and the extended primary gas director output orifice enables a thinner, uniform coating to be applied to a substrate.

Another embodiment of the present invention is an ultrasonic spray coating assembly comprising an ultrasonic converter with spray head with an improved spray forming tip, an improved liquid applicator in close proximity to the spray forming tip, support brackets, an improved gas entrainment mechanism a positive displacement liquid delivery mechanism and an ultrasonic power generator.

Another embodiment of this invention preferably comprises an ultrasonic spray coating assembly with an improved spray forming tip, an improved liquid applicator and an improved gas entrainment system. In the preferred embodiment, the system is capable of spraying liquids onto substrates in a wide, uniform rectilinear pattern at a width proportional to the distance between the spray forming tip and the substrate.

Preferably, the present invention achieves the following benefits over the systems of prior art:
1) Produces a wider spray pattern
2) Produces a more uniform coating distribution
3) Produces a stable spray pattern at a significantly lower flow rate
4) Produces a smaller median drop size
5) Produces a drop size distribution with less variation

Advantageously, one or more of the following improvements are provided over the prior art ultrasonic spray coating system by embodiments of the present invention:
(a) the surface of the feed blade of the ultrasonic spray head is modified to add a series of shallow channels to redirect the ultrasonic surface wave system that exists on the surface.
(b) the internal passageway of the liquid applicator is modified to replace the single passageway with a series of channels to uniformly feed the liquid from the liquid applicator to the spray-forming tip.
(c) a positive displacement pump is utilized to deliver the liquid to the spray head at a precise flow rate independent of the associated resistances of the liquid delivery system components.
(d) the output orifice of the primary gas director is extended to impinge the directed gas stream at a position closer to the spray-forming tip.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed. Other embodiments will be apparent to those skilled in the art from consideration of the specification and practice of the invention disclosed herein.

### BRIEF DESCRIPTION OF THE DRAWINGS

FIG. 1 illustrates the ultrasonic spray coating system including the major components. See FIGS. 1A, 1B, 1C and 1D.

FIG. 2 illustrates the spray forming head part of the ultrasonic spray coating assembly. The input end is connected to the ultrasonic converter and the output end produces the spray.

FIG. 3 illustrates the surface wave system that exists on the surface of the spray forming tip of the ultrasonic spray coating assembly. The surface wave system consists of surface wave on the feed blade surface and a compression wave on the atomizing surface of the spray forming tip.

FIG. 4 illustrates the liquid film that forms on the spray forming tip as the liquid exits the liquid applicator of the ultrasonic spray coating assembly.

FIG. 5 illustrates an ideal depiction of the spray produced by the ultrasonic energy of the ultrasonic spray coating assembly. The spray should be produced in a uniform, sheet-like pattern as it is propelled from the spray forming tip.

FIG. 6 illustrates a depiction of a spray produced in a non-uniform, segmented pattern as it is propelled from the spray forming tip.

FIG. 7 illustrates the direction of the surface wave on the feed blade and the compression wave on the atomizing surface of the spray forming tip.

FIG. 8 illustrates the modified surface of the feed blade to include the series of shallow channels that are used to redirect and concentrate the surface wave that exists on the feed blade surface. See FIGS. 8A, 8B, 8C, 8D and 8E.

FIG. 9 illustrates how the shallow channels on the feed blade surface redirect the surface wave from primarily a z-direction wave to a wave with directional components in the x, y and z directions. See FIGS. 9A, 9B, and 9C.

FIG. 10 illustrates the modified bottom piece of the liquid applicator which contains the liquid flow guide, i.e., a series of channels, within which, the liquid flows through the liquid applicator. See FIGS. 10A, 10B, and 10C.

FIG. 11 illustrates a small section of the spray forming tip with a liquid film of non-uniform thickness on the feed blade surface. Larger drops are propelled from areas where the film is thicker and smaller drops are propelled from areas where the film is thinner.

FIG. 12 illustrates a small section of the spray forming tip with a liquid film of uniform thickness. A uniform film thickness results in a more uniform drop size within the spray propelled from the spray forming tip.

FIG. 13 illustrates a positive displacement pump, such as a syringe pump, used to feed the liquid to the liquid applicator in a controlled manner.

### DETAILED DESCRIPTION OF THE INVENTION

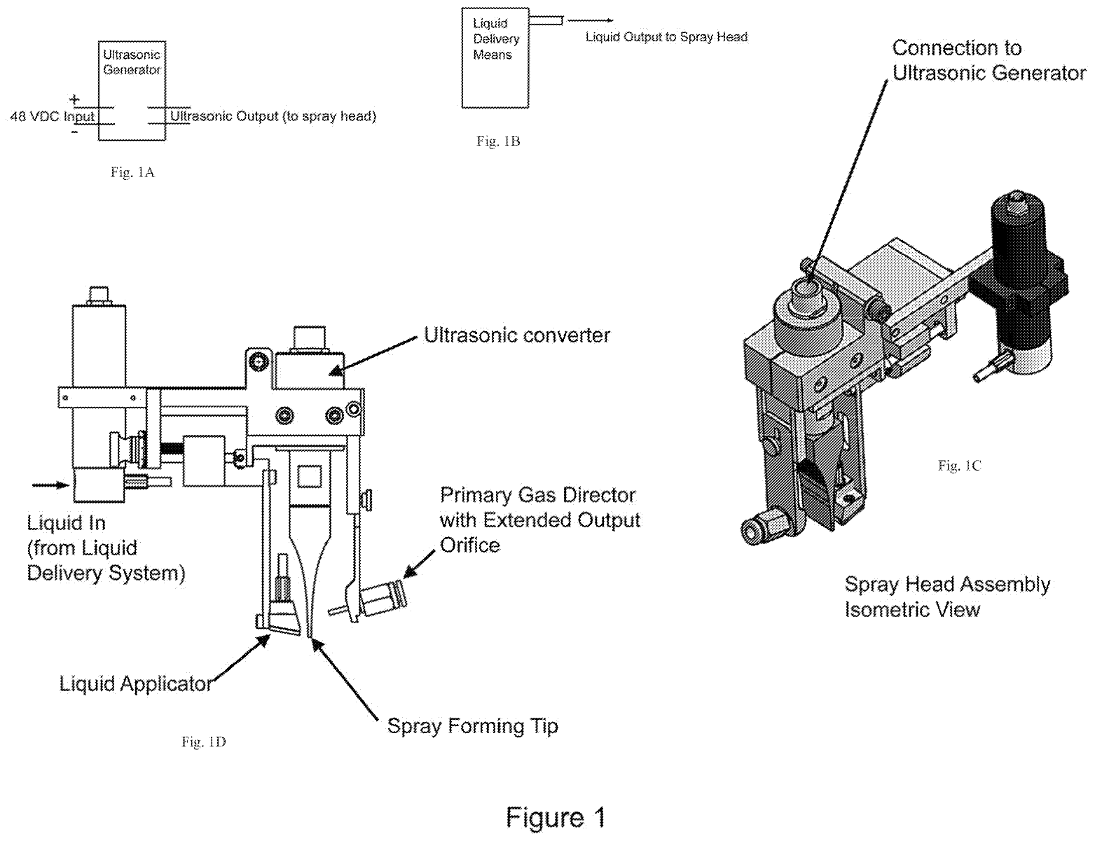

As illustrated in the Figures accompanying this specification, the ultrasonic spray coating system comprises of an ultrasonic spray head assembly and an ultrasonic power generator. As shown in FIG. 1 and in particular FIGS. 1A-1D, the ultrasonic spray head assembly consists of five (5) major components:
(1) Ultrasonic converter coupled to a spray forming head
(2) Liquid applicator
(3) Liquid delivery mechanism
(4) Gas director to expand and shape the spray
(5) Ultrasonic Generator

The ultrasonic power generator drives the ultrasonic spray head. A voltage generator drives the spray head at the proper operating frequency. The circuitry is designed to include the spray head in the frequency control path and to adjust power according to system demand. The operating frequency (fₒ) generated is between the resonant frequency (fᵣ) and the anti-resonant frequency (fₐ) of the spray head, such that a proper ultrasonic wave system is established in the spray forming tip. The principle of operation of the ultrasonic generator and the resulting wave system in the spray forming tip is described in the above referenced prior art patents. The ultrasonic generator is designed to generate and maintain the required operating frequency during changing environments such as ambient temperature. Additionally, the amplitude of the ultrasonic output from the generator is adjustable to accommodate the flow rate requirements of various situations.

The power generator features a unique full bridge power output circuit configuration with a frequency driven pulse mode driver. The high frequency alternating voltage generator utilizes MOSFET power transistors in a bridge type, transformer-coupled configuration (not shown) to provide power to the ultrasonic converter. The DC supply voltage to the bridge circuit is varied to control the level of voltage delivered to the ultrasonic converter.

As described above, one embodiment of the present invention comprises an improved ultrasonic spray coating system having a converter mechanism for converting high frequency electrical energy into high frequency mechanical energy to thereby produce vibrations. The converter mechanism is designed to have one resonant frequency. A spray forming head is coupled to the converter mechanism and is resonant at the same resonant frequency. The spray forming head has a spray forming tip and concentrates the vibrations of the converter at the spray forming tip. The spray forming tip has a feed blade and an atomizing surface. The spray forming tip concentrates a surface wave on the feed blade and a compression wave on the atomizing surface from the vibrations of the converter. A high frequency alternating mechanism is electrically connected to the converter mechanism to produce a controllable level of electrical energy at the proper operating frequency of the spray forming head/converter mechanism such that the spray forming tip is vibrated ultrasonically with a surface wave concentrated on the feed blade and a displacement wave concentrated on the atomizing surface.

A liquid supplier is provided having a liquid applicator in close proximity with the feed blade of the spray forming tip and spaced therefrom. The liquid applicator includes an output surface having an orifice therein. The output surface is in close proximity with the feed blade of the spray forming tip and spaced therefrom. The output surface of the liquid applicator and feed blade of the spray forming tip are at substantially right angles to each other such that the liquid supplied from the liquid applicator forms a bead or meniscus between the output orifice of the liquid applicator and the feed blade of the spray forming tip. The meniscus is formed and sustained by the flow of liquid from the output orifice of the liquid applicator and the ultrasonic surface wave that exists on the feed blade of the spray forming tip. The ultrasonic surface wave enables the liquid to wet-out and adhere to the feed blade of the spray forming tip. The surface tension of the liquid allows the meniscus to form and constant flow of liquid sustains the meniscus. The longitudinal displacement wave, i.e., the wave that displaces the atomizing surface, pumps the liquid from the feed blade to the atomizing surface. A film of liquid then forms on the atomizing surface and is transformed into small drops and propelled from the atomizing surface in the form of a rectilinear spray. Finally, a controllable gas entrainment mechanism is associated with the spray forming head for affecting and controlling the velocity and pattern of the resultant spray.

Improvements to the feed blade of the spray forming tip, the liquid applicator, the primary gas director and the liquid delivery mechanism of the ultrasonic spray coating system are presented herein.

### Spray Forming Head Improvements

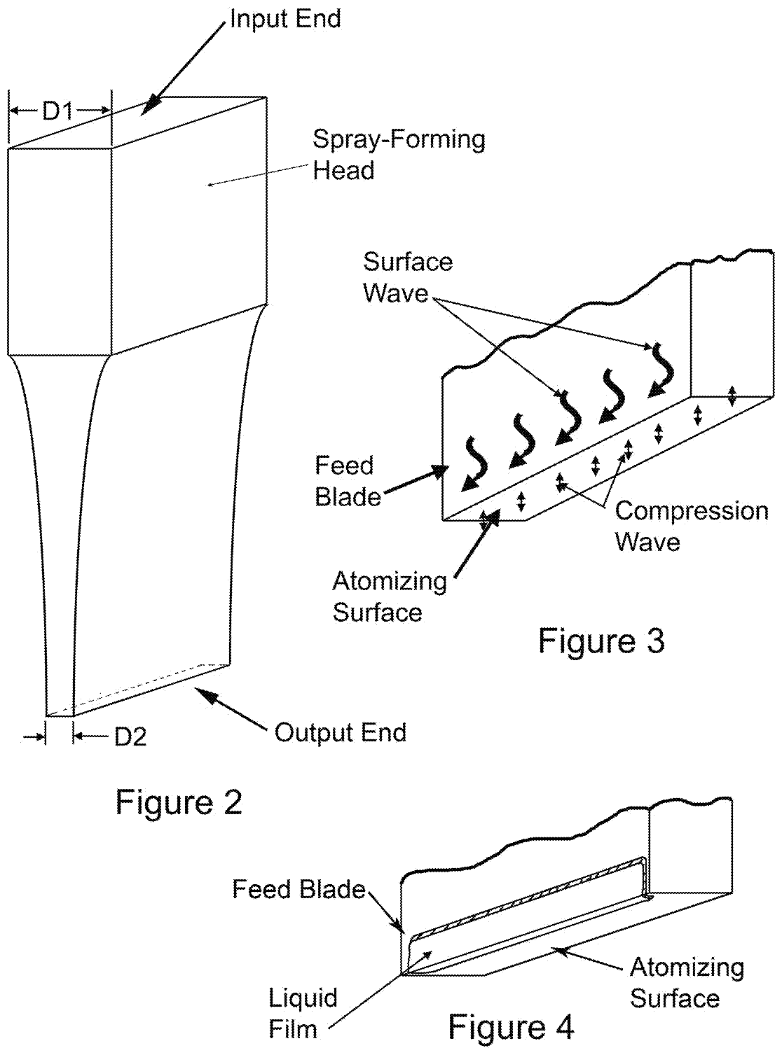

Referring to FIGS. 2, 3, and 4, an ultrasonic spray forming head of the present invention is comprised of an input end, a body and a spray forming tip. The spray forming tip or output end contains a feed blade and an atomizing surface. The spray head has a resonant frequency (fₛₕ) and has a length equal to one-half wavelength (2/2) of the resonant frequency. The wavelength for a particular spray head is defined by:

$$λ = {C}_{m} / {f}_{sh}$$

where:
λ=Wavelength (inches)
Cₘ=material's speed of sound (inches/second)
fₛₕ=resonant frequency (Hertz or 1 cycle/second)

The practical resonant frequencies range from 20 kHz to 120 kHz for atomizing liquids (20 kHz≥fsh≤120 kHz). The spray head is constructed of metal, either 6Al-4V titanium or 7075-T6 aluminum; titanium is preferred because of its strength and corrosion resistance properties.

The input end is comprised of a coupling surface and a coupling screw (not shown). The input end of the spray head is connected to an ultrasonic converter. The input must be flat and smooth for optimal mechanical coupling to the converter. The ultrasonic converter has a resonant frequency (f_{c}) that is matched to the resonant frequency of the spray head (fₛₕ) or f_{c}=fₛₕ.

The spray head body connects the input end to the output end and is formed to concentrate ultrasonic vibrations on the output end. To achieve ultrasonic amplification through the body, the input end must be larger than the output end. The profile of the body can be stepped, linear, exponential or Catenoid. The Catenoid shape is preferred because it provides the largest amplification of the sound wave through the body to the output end, which in turn, provides maximum atomizing capability. Preferable ratios of output end dimension D₂ to input end diameter (D₁) are:

$$4 \geq ( {D}_{1} / {D}_{2} ) \leq 8$$

The Catenoid shape is described by the catenoidal equation:

$$Y = {Y}_{o} * cosh [ m ( X - {X}_{o} ) ]$$

where: X→X coordinate
   Y→Y coordinate at X
   Xₒ→X coordinate of the lowest point on Catenoid
   Yₒ→Y coordinate of the lowers point on Catenoid
   Cosh→hyperbolic cosine
   M→Constant (depends on the end points of the Catenoid)

Referring to the detail in FIG. 3, the spray forming tip has two main features: (1) an atomizing surface that provides concentrated ultrasonic vibrations with sufficient energy to atomize a flowing liquid, and (2) a feed blade that causes a liquid that is applied to it to flow to the atomizing surface. The feed blade surface and the atomizing surface are at substantially right angles to each other.

The purpose of the feed blade is to direct all of the liquid flow from the liquid applicator toward and onto the atomizing surface. The wave system that exists on the feed blade and the atomizing surface of the spray-forming tip is described in detail in the prior art patents referenced above. The wave system, as shown in FIG. 3, consists of a surface wave on the feed blade and a compression wave on the atomizing surface. The surface wave causes the liquid to form a liquid film on the feed blade and then pumps the liquid from the feed blade, over the right-angle edge, to the atomizing surface of the spray-forming tip. See, FIG. 4.

To produce a uniform spray pattern from the spray-forming tip, it is essential that (1) the liquid is delivered uniformly to the feed blade across its width by the liquid applicator and (2) that the liquid is delivered uniformly from the feed blade to the atomizing surface across its width. These two conditions ensure that a liquid film (see, FIG. 4) of uniform thickness is first formed on the feed blade and then pumped to the atomizing surface of the spray-forming tip where it is instantaneously broken up into small drops by the energy of the ultrasonic compression wave.

The liquid film shown in FIG. 4 is part of the meniscus that forms between the output orifice of the liquid applicator and the feed blade of the spray forming tip. The liquid film is the section of the liquid meniscus that contacts the feed blade and is of the same thickness as the film that forms on the atomizing surface of the spray forming tip. FIG. 4 shows a liquid film being transferred from the feed blade to the atomizing surface of the spray-forming tip; this is for illustrative purposes only since the film is immediately atomized at the leading edge of the atomizing surface.

Once the liquid is broken up into small drops, the drops are propelled them from the tip in the form of a spray. The size of the drops produced by compression wave is directly proportional to the thickness of the liquid film that is delivered to the atomizing surface from the feed blade. The drop size variation is also directly proportional to the liquid film thickness variation delivered to the atomizing surface. Also, the contiguity of the stream of drops being propelled from the atomizing surface is directly related to the contiguity of the liquid film that is delivered to aforementioned atomizing surface.

The size of the drops, the drop size distribution, and the contiguity of the spray pattern and the shape of the spray pattern define the quality of the spray pattern. Therefore, the quality of the spray pattern is directly related to the uniformity of the liquid film that is delivered to the atomizing surface by the pumping action of the feed blade from the meniscus of liquid that is formed between the liquid applicator and the feed blade. Additionally, the coating deposition on the substrate is directly related to the quality of the spray pattern. A uniform spray pattern will produce a uniform coating deposition on the substrate to be coated.

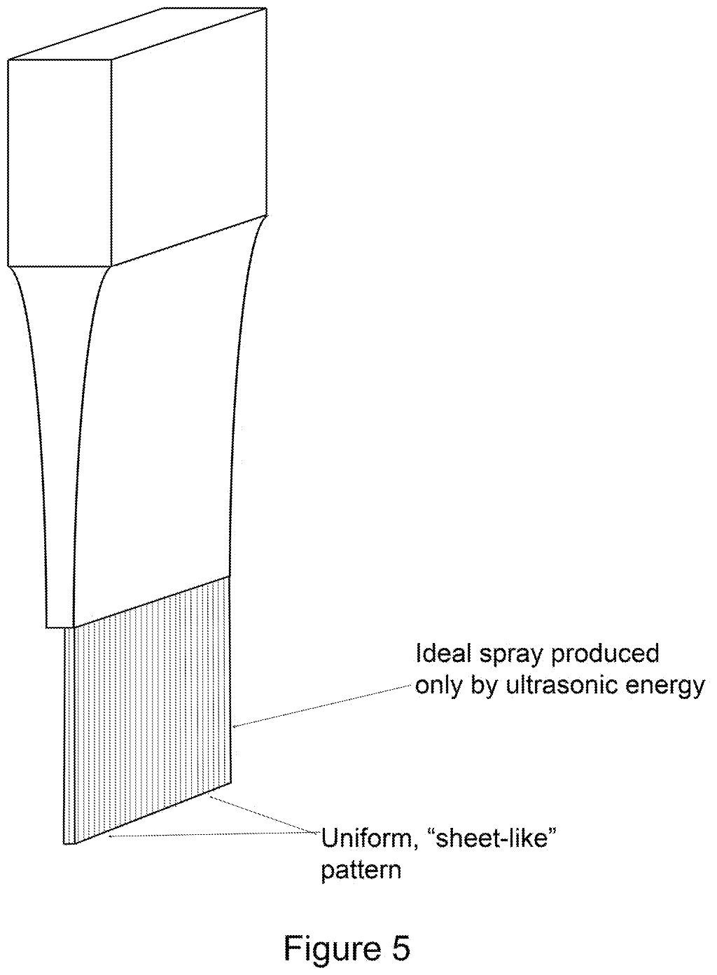

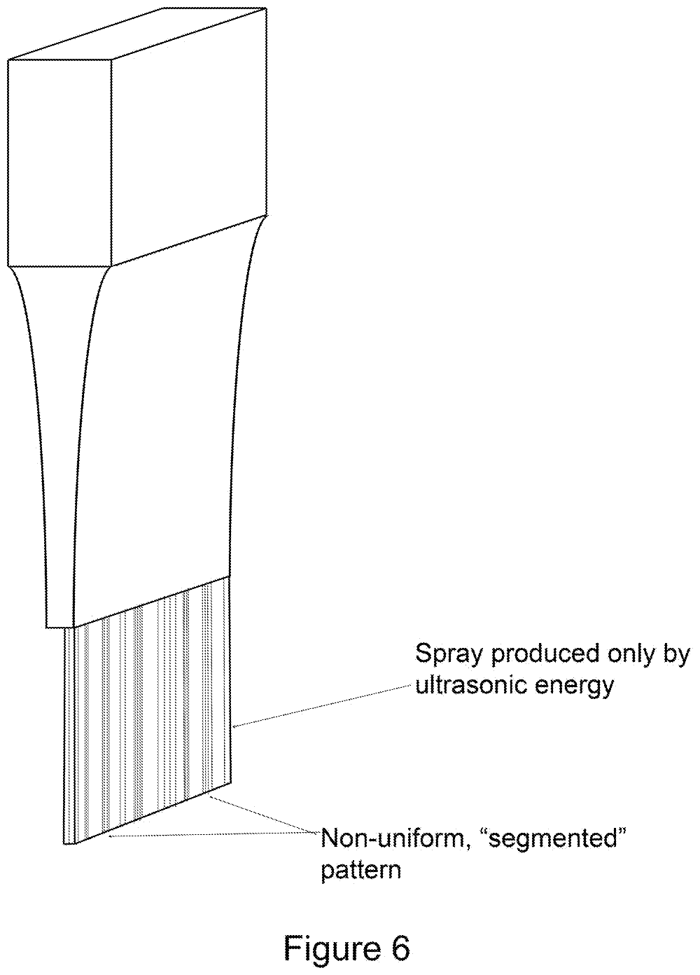

This pumping action of the feed blade wave system is effective in causing the liquid to form a uniform film on the surface of the feed blade and delivering the uniform liquid film from the liquid applicator to the atomizing surface of the spray-forming tip, within certain operating parameters, such as the flow rate and surface tension for a particular liquid. When the liquid flow rate and liquid surface tension are within certain limits, a very uniform, sheet-like, spray is produced by the spray-forming tip, as can be seen in FIG. 5. However, if the liquid flow rate is decreased below the minimum limit or if a given liquid has a higher surface tension than the nominal required for film formation, the ability to produce a uniform sheet-like spray pattern decreases. Either or both of these conditions will result in a non-uniform, segmented spray as shown in FIG. 6.

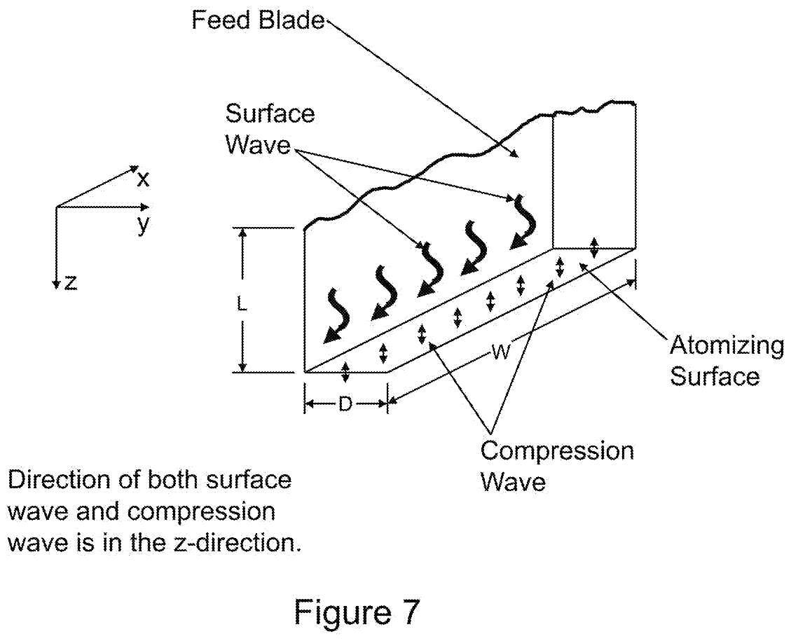

As illustrated in FIG. 7, the surface wave system that exists on the flat feed blade produces a pumping force for the liquid in the z-direction and directs the liquid toward the atomizing surface. However, the surface wave imparts no forces in the x-direction to resist any tendency of the liquid to flow side-to-side across the width of the feed blade.

When the liquid flow rate is within the nominal operating range, a uniform meniscus is formed between the liquid applicator and the spray-forming tip across the width of the tip in the x-direction. As the flow rate is decreased below the lower operating limit, the spray pattern deteriorates into individual segments that move at random across the width of the spray-forming tip. The formation of the individual segments and their random movement is due to the lack of resistance to liquid flow in the x-direction by the surface wave. The uniform meniscus is broken by the surface tension of the liquid and individual streams are formed between the liquid applicator and the spray-forming tip. The surface wave on the feed blade pumps the individual segments to the atomizing surface, which results in a non-uniform or segmented spray being propelled from the spray-forming tip and thus a non-uniform coating deposition on the substrate.

Individual segments form as the liquid flow rate decreases below the minimum limit for a liquid with a given surface tension. The higher the liquid's surface tension, the higher the minimum flow rate required to achieve a uniform spray pattern. For example, when spraying a higher surface tension liquid, like plain water, the lowest flow rate at which a uniform, rectilinear pattern can be produced is approximately 15 ml per minute. When spraying a lower surface tension liquid like ethanol, the lowest flow rate at which a uniform, rectilinear pattern can be produced is approximately 10 ml per minute. Once the liquid flow rate is reduced below these lower limits, the individual segments are formed as the surface tension of the liquid breaks the meniscus.

An additional problem is that the individual liquid streams feeding the atomizing surface produce a film of varying thickness across the width of the atomizing surface. A thicker liquid film on the atomizing surface produces larger drops and a thinner film produces smaller drops. A spray pattern that consists of segments of larger drops and segments of smaller drops also produces a non-uniform coating distribution on the substrate to be coated. Ideally a film of uniform thickness across the entire width of the atomizing surface is desired to produce a drop size distribution with less variation within the spray pattern.

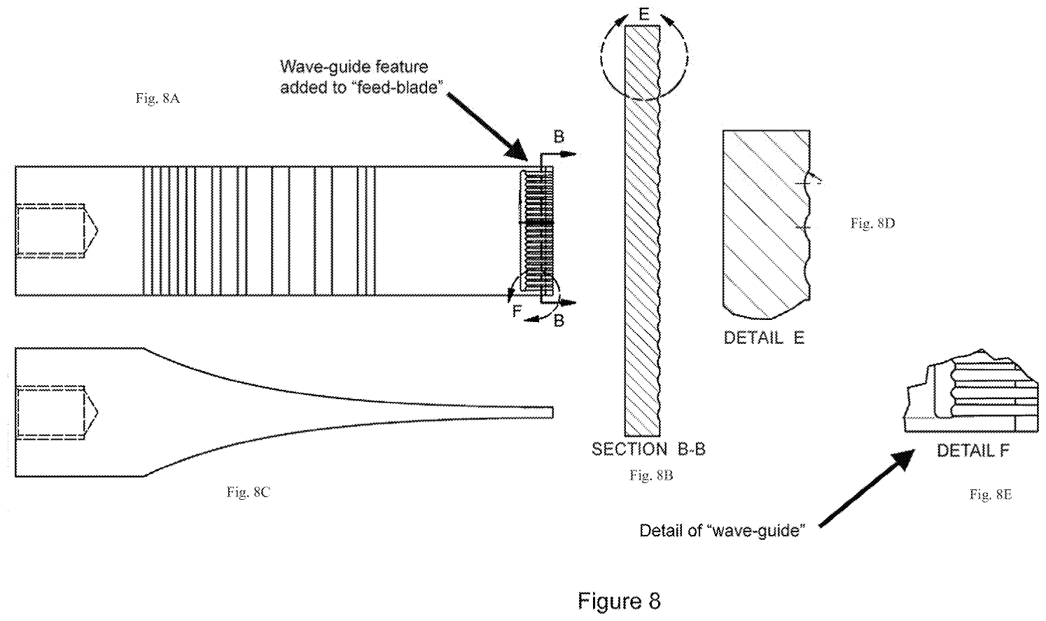

Referring to the detail in FIG. 8, and particularly FIGS. 8A-8E, the feed blade has been modified to redirect and concentrate the ultrasonic wave system to overcome the above-described problems. A channel system feature, in the form if a series of shallow channels, is machined onto the surface of the feed blade. These channels transform the z-direction surface waves into surface waves that have x and y directional components as well.

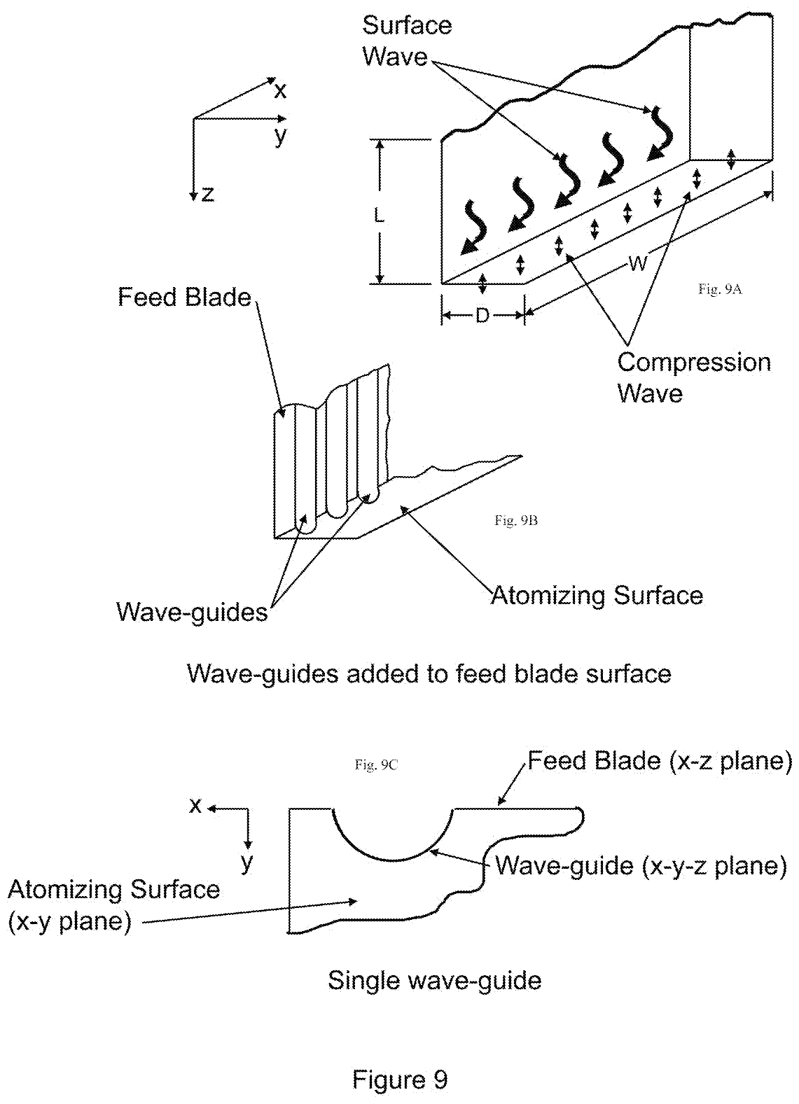

FIG. 9, and particularly FIGS. 9A-9C, together illustrate the spray forming tip with a surface wave that exists on the feed blade with a pumping action in the z-direction and a compression wave that exists on the atomizing surface that breaks the liquid delivered from the feed blade into small droplets. A small section of the spray-forming tip is also shown that has the channel system added to the feed blade. A single channel is also detailed showing the feed blade in the x-z plane and the atomizing surface in the x-y plane of the spray-forming tip. The feed blade without the added channel system is on the x-z plane of the spray-forming tip of the spray assembly. The surface wave pumps in the z-direction on the un-modified feed blade. The addition of the channel system redirects the surface wave so that it also has components in the x and y directions due to the change in shape. The feed blade now exists in the x-y-z plane with the pumping action primarily in the z-direction. However, there are now components of the wave-action in the x and y directions, which resist the tendency of liquid flow side-to-side across the feed blade surface.

This channel system provides a guided wave action to focus and concentrate the pumping force in the z-direction and also to aid in overcoming the surface tension of the liquid, which reduces the tendency for side-to-side (x-direction) liquid flow across the width of the feed blade and the formation of individual liquid streams. The result is the formation of a more uniform film of liquid across the surface of the feed blade and consequently a more uniform flow of liquid from the feed blade onto the atomizing surface of the spray-forming tip. A more uniform flow of liquid to the atomizing surface results in a uniform film of liquid on the atomizing surface, which produces a more uniform spray pattern, smaller drops and less variation in the drop sizes produced.

The size of drops produced with ultrasonic energy is inversely proportional to the ultrasonic frequency and directly related to the thickness of the film formed on the atomizing surface of the spray-forming head just prior to atomization. A thinner film will produce smaller drops and a thicker film will produce larger drops. A film of uniform thickness of liquid being fed to the atomizing surface will produce a more uniform drop size distribution. While a film of varying thickness across the atomizing surface will produce a drop size distribution with much more variation in drop size.

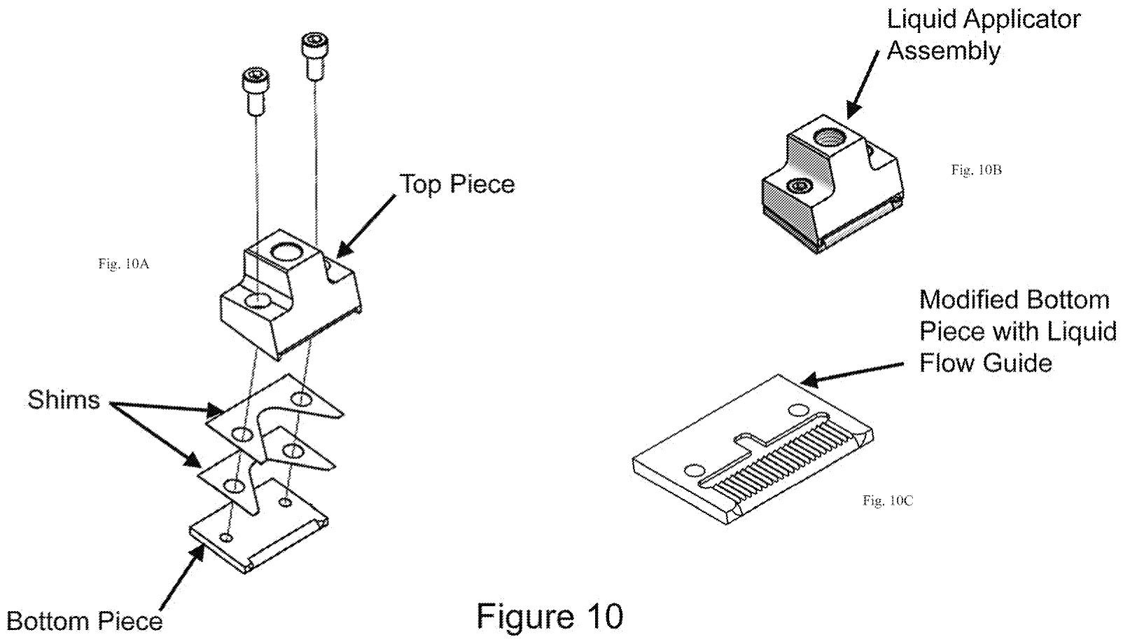

In order to compliment the ultrasonic wave-guide on the feed blade of the spray-forming tip, a liquid flow guide is added to the inside of the liquid applicator. FIG. 10, and particularly FIGS. 10A-10C, together show the original liquid applicator configuration (10A) as well as the improved liquid applicator (10C) with the added flow guides. The liquid applicator transforms the liquid flow path from a tube flow to a line flow. The liquid flows in a tube from the liquid delivery system to the liquid applicator where it is fed through a rectangular passageway and exits through a slot and delivered to the feed blade of the spray-forming tip of the spray assembly. In the original liquid applicator configuration, the liquid is fed through the passageway created between the top piece and bottom piece by shims. The shims create a v-shaped cavity within the liquid applicator and ensure that the top and bottom pieces are evenly spaced. The liquid is fed though an opening in the top piece of the applicator to the apex of the v-shaped cavity and exits through the slot formed between the top and bottom pieces. The liquid is free to flow from the inlet port to the output surface between the flat plats and side surfaces. However, the liquid is free to flow from side-to-side with no restriction. Liquids with higher a surface tension tend to flow in random streams within the liquid passageway.

The modified bottom piece of the liquid applicator contains the liquid flow guide is also shown in FIG. 10C. The flow guide is a series of channels, within which, the liquid flows through the liquid applicator. The liquid guide channels within the liquid applicator forces the liquid to flow evenly from the inlet port through the liquid applicator to the feed blade of the spray head by dividing the liquid into individual streams within the liquid applicator. This is most important for higher surface tension liquids, which have a tendency to follow random paths through the liquid applicator passageway without the liquid flow guide system. The new liquid applicator passageways restrict the flow of liquid from the inlet port to the output surface thus forcing the liquid to flow evenly through each channel to the meniscus between the liquid applicator and the feed blade of the spray-forming tip. The depth the channels can be adjusted for the properties of the particular liquid being sprayed.

It should be noted that the liquid flow guide passageways within the liquid applicator and the wave guide feature on the feed blade of the spray forming tip do not necessarily match. In other words, the flow guide channels within the liquid applicator do not need to have the same number of channels as the wave-guides on the feed blade, nor do the channels need to line up with one another.

With these improvements the lower flow rate limit for producing a uniform sheet-like spray pattern with plain water is reduced from approximately 15 ml per minute to less than 10 ml per minute. Similar flow rate reductions are achieved with other liquids. Additionally, since the liquid film on the atomizing surface is thinner and more uniform, the median drop size is smaller and the drop size variation is considerably reduced. This enables a thinner, more uniform coating to be applied to a substrate.

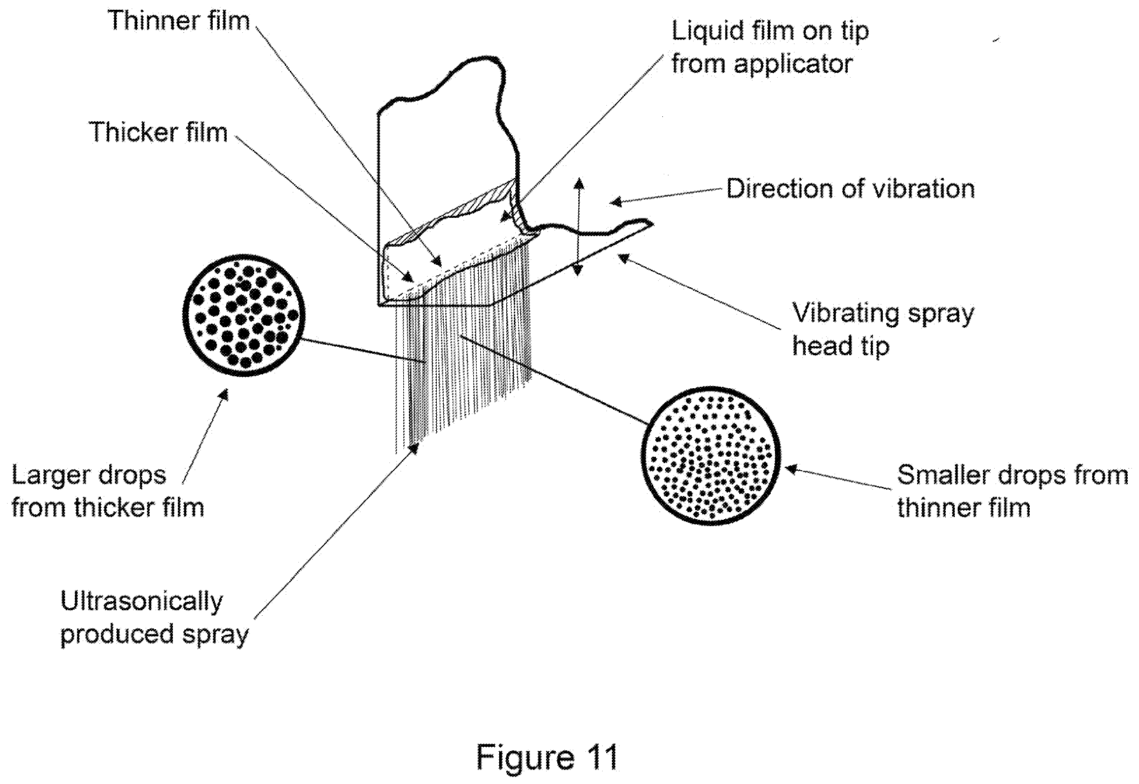

FIG. 11 shows a small section of the spray forming tip of the ultrasonic spray assembly. The liquid applicator is not shown; instead the liquid film from the liquid applicator that forms on the feed blade is shown. In this case, the liquid film that forms on the feed blade does not have a uniform thickness. The film is pumped from the feed blade to the atomizing surface of the spray forming tip by the surface wave that exists on the feed blade. The compression wave that exists on the atomizing surface breaks the liquid film into small drops and propels then from the tip in the form of a spray. Since the film on the feed blade has a varying thickness, the corresponding droplets that are formed on the atomizing surface have a varying size distribution in proportion to the film thickness on the feed blade. Larger drops are produced from a thicker film and smaller drops are produced from a thinner film. The coating on the substrate from this non-uniform liquid film on the feed blade will also be non-uniform with a thicker coating resulting in the areas sprayed by the larger droplets and a thinner coating in the areas sprayed by the smaller droplets.

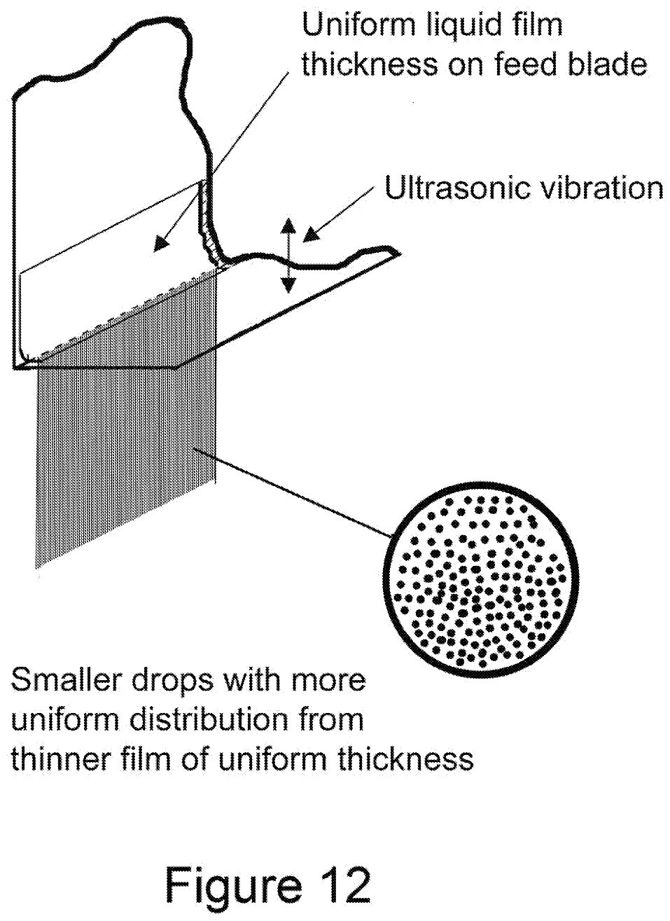

FIG. 12 shows a small section of the spray-forming tip of the ultrasonic spray assembly, similar to FIG. 11. In this case, the liquid film on the feed blade has a uniform thickness across the surface of the feed blade. This uniform film thickness on the feed blade results in smaller droplets with a more uniform size distribution being formed at the atomizing surface. These smaller, more uniform droplets result in a more uniform coating on the substrate. The primary object of this invention is to deliver a thinner, more uniform liquid film to the atomizing surface of the spray assembly to produce a smaller more uniform drop size distribution.

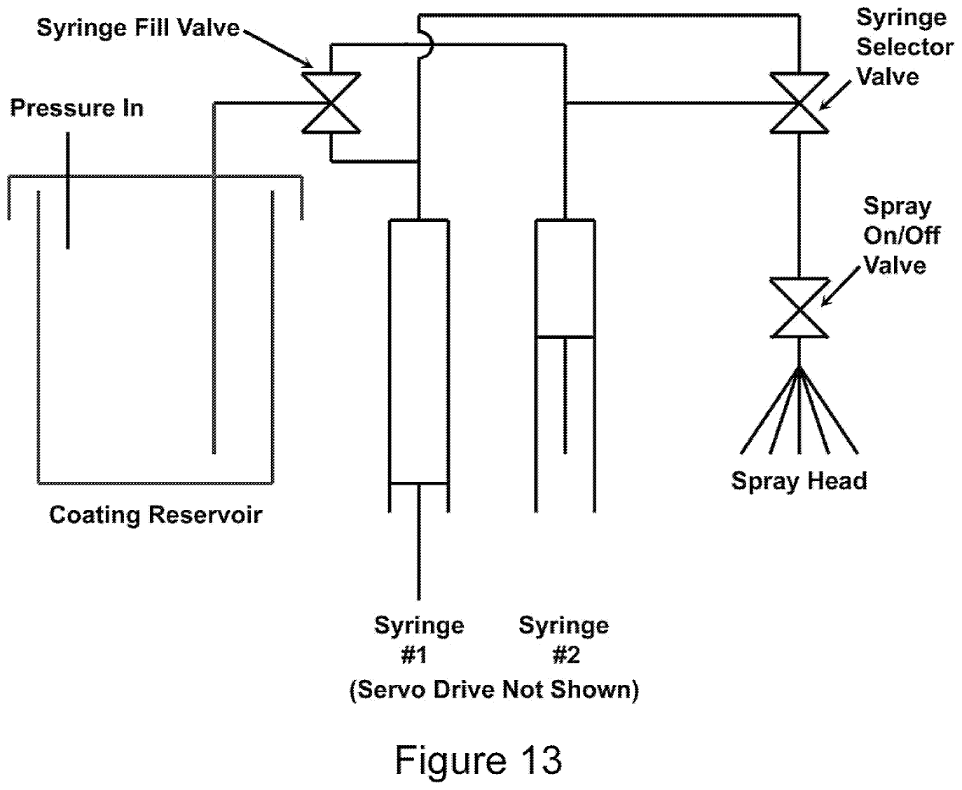

As illustrated in FIG. 13, the liquid may be fed to the liquid applicator with a positive displacement pump, for example a syringe pump, to ensure that the passageways in the liquid applicator do not influence the liquid flow rate. A positive displacement pump ensures that the liquid is supplied to the spray head at a precise flow rate independent of the associated resistances of the liquid lines, fittings, etc. The positive displacement pump is designed with a dual piston system and liquid storage reservoir so that the flow of liquid to the spray head is not interrupted when one of the syringes is empty.

The gas directors are used to expand and shape the spray generated by the spray-forming tip of the spray head. As illustrated in FIG. 1D, the improvement in the gas entrainment system is to extend the primary gas director output orifice to focus the gas stream that is impinged onto the spray head tip. The focused gas stream increases the width that the ultrasonically produced spray can be expanded. For example, without the improved primary gas director, the maximum expanded spray width is approximately 100 mm and with the improvement, the maximum expanded spray width is approximately 215 mm.

The increased spray pattern width coupled with the lower limit to produce a uniform spray pattern further improves the ability to apply a thin, uniform coating to a substrate. These improvements enable a given coating to be applied over three times thinner than prior art.

As used herein, the singular forms “a”, “an” and “the” include plural unless the context clearly dictates otherwise. Moreover, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

What is claimed is:

1. An ultrasonic spray coating system comprising:
a converter for converting high frequency electrical energy into high frequency mechanical energy to thereby produce vibrations,
a spray forming head coupled to said converter, said spray forming head having a narrowed spray forming tip with substantially planar opposing side surfaces, the spray forming tip terminating at a substantially planar atomizing surface, one of the side surfaces comprising a feed blade being substantially perpendicular to the atomizing surface;
a high frequency alternating generator electrically connected to said converter for producing a controllable level and frequency of electrical energy at an operating frequency of said spray forming head and converter wherein the atomizing surface is uniformly displaced in a normal direction by the vibrations and wherein a surface wave component is induced in the first region along the feed blade, the surface wave component being in a direction toward the atomizing surface;
a liquid applicator in close proximity with the first region of said feed blade and spaced therefrom, said liquid supply applicator having an output surface including an orifice therein, such that liquid supplied from the output orifice to the feed blade is caused to flow to and on said atomizing surface under the influence of said surface wave component and said liquid is atomized by the displacement of said atomizing surface and is thereby changed to a spray; and
a controllable gas entrainment mechanism associated with said spray forming head, the gas entrainment mechanism including a primary gas director for directing a first stream of gas at a region of the side surface of the spray forming tip opposite said feed blade, an angle measured between the first stream of gas and the side surface opposite said feed blade being less than 90° such that the first stream of gas impinges off the region thereby forming a fan-shaped air pattern in a direction substantially normal to the atomizing surface for affecting and controlling said spray.

2. The ultrasonic spray coating system of claim 1, wherein the surface feed blade comprises a series of shallow channels to redirect and concentrate the surface wave component that exists on this surface, such that the surface wave has directional components in the x, y and z planes.

3. The ultrasonic spray coating system of claim 1, wherein the inside orifice of the liquid supply applicator comprises a series of liquid guide channels to form a liquid flow guide.

4. The ultrasonic spray coating system of claim 1, wherein the output orifice of the primary gas director is extended to bring the output orifice closer to the impingement surface of the spray forming head.

5. The ultrasonic spray coating system of claim 3, further comprising a positive displacement pump to deliver liquid to the spray forming tip at a precise flow rate independent of the associated resistance to flow created by the liquid guide channels inside the liquid supply applicator.

6. The ultrasonic spray coating system of claim 2, wherein the surface wave with three (3) directional components redirects the liquid flow over the surface of the feed blade to form a film with a more uniform thickness.

7. The ultrasonic spray coating system of claim 2, wherein the surface wave with three (3) directional components pumps the more uniform liquid film to the atomizing surface of the spray forming tip producing a spray containing drops with a smaller median drop size.

8. The ultrasonic spray coating system of claim 2, wherein the surface wave with three (3) directional components pumps the more uniform liquid film to the atomizing surface of the spray forming tip producing a spray containing drops with a more uniform drop size distribution.

9. The ultrasonic spray coating system of claim 4, wherein the extended output orifice of the primary gas director enables the ultrasonically produced spray to be expanded to a greater expanded width by more than a factor of 2.

10. The ultrasonic spray coating system of claim 2 or 3, wherein the combination of the modified feed blade surface and the modified liquid supply applicator orifice enables a uniform spray to be produced by the spray forming tip at a substantially lower flow rate.

11. The ultrasonic spray coating system of claim 2, 3 or 4, wherein the combination of the modified feed blade surface, the modified liquid supply applicator orifice and the extended primary gas director output orifice enables a thinner, uniform coating to be applied to a substrate.
